(19) United States
(12) Patent Application Publication
(10) Pub. No.: US 2021/0306680 A1
(43) Pub. Date: Sep. 30, 2021

(54) SYSTEM, METHOD, USER EQUIPMENT AND COMPUTER-READABLE RECORDING MEDIUM FOR LIVE STREAMING ACTIVITY

(71) Applicant: Acer Incorporated, New Taipei City (TW)

(72) Inventors: Chia-Shang Yuan, New Taipei City (TW); Meng-Han Chou, New Taipei City (TW)

(73) Assignee: Acer Incorporated, New Taipei City (TW)

(21) Appl. No.: 17/005,281

(22) Filed: Aug. 27, 2020

(30) Foreign Application Priority Data
Mar. 27, 2020 (TW) 109110612

(51) Int. Cl. H04N 21/2187; H04N 21/442; H04N 21/258; H04N 21/81; H04N 21/431

(52) U.S. Cl. CPC H04N 21/2187; H04N 21/44222; H04N 21/431; H04N 21/812; H04N 21/25891

(57) ABSTRACT

A system, a method, user equipment, and a computer-readable recording medium for a live streaming activity are provided. The system includes an activity broadcasting platform server and the user equipment. The activity broadcasting platform server establishes a webpage associated with an activity and has a database recording a multimedia material associated with the activity. The user equipment is connected to the activity broadcasting platform server through a network and obtains a multimedia material from the activity rebroadcasting platform server through the network. The user equipment generates a plurality of activity pictures in response to conduction of the activity and integrates the activity pictures and the multimedia material to generate a live video stream. The user equipment provides the live video stream to a live streaming platform server to instantly broadcast the live video stream via the live streaming platform server.

### CROSS-REFERENCE TO RELATED APPLICATION

This application claims the priority benefit of Taiwan application serial no. 109110612, filed on Mar. 27, 2020. The entirety of the above-mentioned patent application is hereby incorporated by reference herein and made a part of this specification.

### BACKGROUND

### 1. Technical Field

The disclosure relates to a live streaming technology, and in particular, to a system, a method, user equipment, and a computer-readable recording medium for a live streaming activity.

### 2. Description of Related Art

With the advancement of science and technology, entertainment audio and videos transmitted via a network are readily available, changing people's video viewing behaviors. Online video brings new interaction and viewing experience from sitting in front of a TV screen at a fixed time to watching on-demand online videos as desired. In particular, nowadays, people are accustomed to watching live audio and video streams using the network, for example, live streaming of major competitions or performances, monitoring of roads or buildings, live streaming of game picture captures, distance teaching, online live news, live streaming of disaster sites, etc.

In addition, with the vigorous development of the e-sports industry, computer games gradually become the main leisure and entertainment in people's daily life nowadays. Further, the numbers of e-sports players and related e-sports events are on the rise as well. In the early phase, only professional events or specific key events are broadcast by a professional production team. However, with the maturity of live streaming software and live streaming platforms, general amateur players may also begin to use a personal computer to perform live streaming of live e-sports events on their own. For example, general amateur players may use free live streaming software (for example, Open Broadcaster Software, etc.) to easily broadcast game pictures to audiences around the world through a live streaming platform (for example, YouTube or Twitch, etc.). However, compared to the live broadcasts produced by professional teams, most of the live contents produced by general amateur players include only game pictures, which are relatively tedious and less informative, and are boring and uninteresting for viewers. In addition, the live streaming produced by general amateur players may not be noticed easily by viewers around the world most of the time and relies heavily on long-term word-of-mouth reputation or are usually limited to exposure by fixed live streaming platforms.

### SUMMARY

Accordingly, the disclosure provides a system, a method, user equipment, and a computer-readable recording medium for a live streaming activity through which exposure of the live streaming activity is increased and rich live streaming content is provided.

An embodiment of the disclosure provides a system for a live streaming activity, including an activity broadcasting platform server and user equipment. The activity broadcasting platform server is configured to establish a webpage associated with an activity and includes a database configured to record a multimedia material associated with the activity. The user equipment is connected to the activity broadcasting platform server through a network and is configured to obtain the multimedia material from the activity broadcasting platform server through the network. The user equipment generates a plurality of activity pictures in response to conduction of the activity, integrates the activity pictures and the multimedia material to generate a live video stream, and provides the live video stream to a live streaming platform server to instantly broadcast the live video stream via the live streaming platform server.

An embodiment of the disclosure provides a method for a live streaming activity applicable to user equipment connected to a network. The method includes the following steps. An activity broadcasting platform server is connected through a network. A multimedia material associated with an activity is obtained from the activity broadcasting platform server through the network. A plurality of activity pictures are generated in response to conduction of the activity. The multimedia material and the activity pictures are integrated to generate a live video stream. The live video stream is provided to a live streaming platform server to instantly broadcast the live video stream via the live streaming platform server.

An embodiment of the disclosure provides user equipment including a network device, a storage apparatus, and a processor. The network device is connected to a network, and the processor is coupled to the network device and the storage apparatus. The processor is configured to perform the following steps. An activity broadcasting platform server is connected through a network. A multimedia material associated with an activity is obtained from the activity broadcasting platform server through the network. A plurality of activity pictures are generated in response to conduction of the activity. The multimedia material and the activity pictures are integrated to generate a live video stream. The live video stream is provided to a live streaming platform server to instantly broadcast the live video stream via the live streaming platform server.

An embodiment of the disclosure provides a computer-readable recording medium recording a computer program. The computer program may be loaded by the processor of the user equipment to perform the steps of the method for the live streaming activity.

Based on the above, in the embodiments of the disclosure, the user equipment may generate a live video stream by using the multimedia material provided by the activity broadcasting platform server. Based on this, by integrating the activity pictures and the multimedia material related to the activity, the user equipment can generate rich and interesting live video streams. In addition, general audiences may obtain the live streaming information of the activity through the webpage established by the activity broadcasting platform server, so that the live streaming activity may attract attention from increased audiences.

To make the features and advantages of the disclosure clear and easy to understand, the following gives a detailed description of embodiments with reference to accompanying drawings.

### BRIEF DESCRIPTION OF THE DRAWINGS

FIG. 1 is a schematic diagram of a system for a live streaming activity according to an embodiment of the disclosure.

FIG. 2 is a schematic diagram of user equipment according to an embodiment of the disclosure.

FIG. 3 is a schematic diagram of an activity broadcasting platform server according to an embodiment of the disclosure.

FIG. 4 is a schematic flow chart of a method for a live streaming activity according to an embodiment of the disclosure.

FIG. 5A and FIG. 5B are schematic diagrams of a scenario in which a live video stream is generated according to an embodiment of the disclosure.

FIG. 6 is an exemplary schematic diagram of a live streaming picture according to an embodiment of the disclosure.

### DESCRIPTION OF THE EMBODIMENTS

Some embodiments of the present disclosure will be described in detail below with reference to the accompanying drawings. For reference symbols used in the following descriptions, same reference symbols in different drawings represent same or similar components. These embodiments are merely a part of the present disclosure, and do not disclose all possible implementations of the present disclosure. More specifically, these embodiments are merely examples of a method, a system, and an apparatus in the claims of the present disclosure.

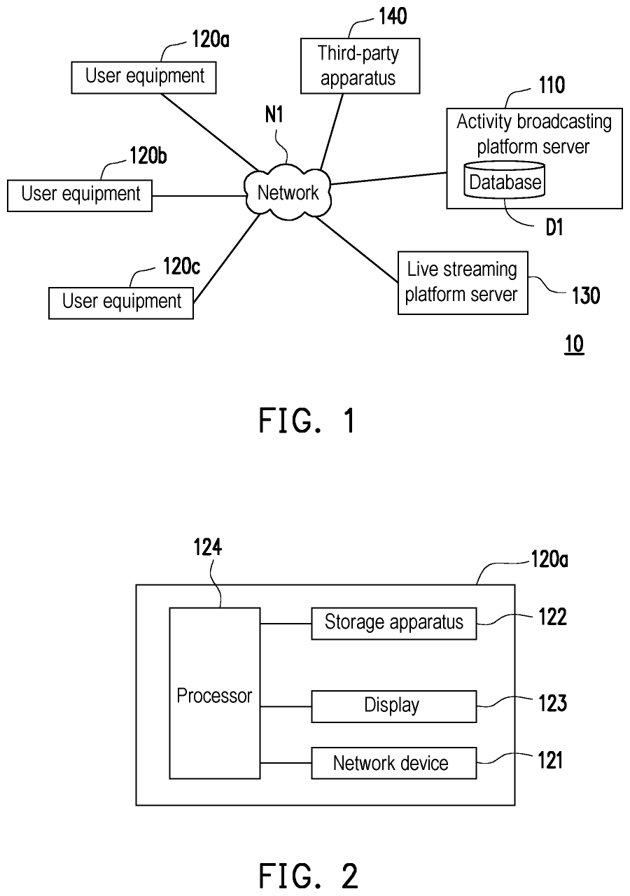

FIG. 1 is a schematic diagram of a system for a live streaming activity according to an embodiment of the disclosure. Referring to FIG. 1, a system 10 for a live streaming activity may include an activity broadcasting platform server 110, user equipment 120a to user equipment 120c, a live streaming platform server 130, and a third-party apparatus 140. The user equipment 120a to the user equipment 120c are, for example, desktop computers or notebook computers, which are not limited by the disclosure. The user equipment 120a to the user equipment 120c may be connected to the activity broadcasting platform server 110 and the live streaming platform server 130 through a network N1. In the present embodiment, the network N1 may include a wireless or wired communication network, such as a wired Internet, worldwide interoperability for microwave access (WiMAX), fourth-Generation communication (4G), fifth-Generation communication (5G), ultra-wide band (UWB), etc.

However, it should be noted that a number of pieces of the user equipment is not limited in the disclosure. In order to clearly illustrate the disclosure, the user equipment 120a is used as an example for description below. In an embodiment, the user equipment 120a may conduct an activity and perform live streaming of live activity pictures of the activity. The activity is, for example, an e-sports competition, an item sales activity, or distance teaching, etc. The activity pictures may be application pictures, video images from a camera apparatus, or captured pictures of a window, etc. The user equipment 120a may execute live streaming tool software to generate a live video stream, and provide the live video stream to the live streaming platform server 130, so that the live streaming platform server 130 can broadcast the live video stream generated by the user equipment 120a. A live streaming platform corresponding to the live streaming platform server 130 is, for example, YouTube, Facebook, Twitch, etc. No limitation is imposed on this in the disclosure. The live streaming platform server 130 may instantly broadcast the live video stream provided by the user equipment 120a through the network NI, so that a viewer can watch, through a playback apparatus connected to the live streaming platform server 130, live streaming content generated by the user equipment 120a.

In an embodiment, the live streaming platform server 110 has a database D1. The database D1 records a multimedia material related to the activity conducted by the user equipment 120a. A format of the multimedia material includes at least one of an image file, a text message, and a video file. In addition, content of the multimedia material may include advertisement information or information related to the activity conducted by the user equipment 120a. Alternatively, the content of the multimedia material may include interaction information of an audience interaction interface. The audience interaction interface is presented on a webpage established by the activity broadcasting platform server 110, such as a chat room interface, a rating interface, or a like interface, etc.

In an embodiment, the activity broadcasting platform server 110 may transmit, to the user equipment 120a through the network N1, the multimedia material in the database D1 or a multimedia material provided by the third-party apparatus 140. The third-party apparatus 140 is, for example, an activity sponsor, an advertiser, or an activity creator, etc., and may be connected to the activity broadcasting platform server 110 through the network N1. Therefore, the user equipment 120a obtains the multimedia material from the activity broadcasting platform server 110 through the network N1, so as to integrate the multimedia material into the activity pictures to generate a live video stream including a plurality of live streaming pictures. For example, the user equipment 120a may integrate the advertisement information or the activity-related information provided by the activity broadcasting platform server 110 and an e-sports competition picture generated by the user equipment 120a, to generate a live video stream, so that viewers can watch live streaming content including the advertisement information or the activity-related information and live streaming content of the game picture. In other words, the activity broadcasting platform server 110 may push the advertisement information or the activity-related information to the user equipment 120a, and the live streaming content generated by the user equipment 120a carries various related information provided by the activity broadcasting platform server 110, so that the live streaming content generated by the user equipment 120a is rich and interesting.

In an embodiment, the activity broadcasting platform server 110 may establish, via a website interface, a webpage related to the activity conducted by the user equipment 120a. The webpage may include live streaming information of the activity, for example, a live streaming web address or live streaming time point, etc. The webpage established by the activity broadcasting platform server 110 may include an audience interaction interface associated with the activity. In an embodiment, when the user equipment 120a to the user equipment 120c conduct a same activity, for example, participate in a same e-sports competition, the webpage established by the activity broadcasting platform server 110 may include a plurality of live broadcast streaming pictures generated by the user equipment 120a to the user equipment 120c and a plurality of live streaming web addresses corresponding to the user equipment 120a to the user equipment 120c, respectively.

FIG. 2 is a schematic diagram of user equipment according to an embodiment of the disclosure. An embodiment of the user equipment 120a shown in FIG. 2 is merely an example, and the user equipment 120b to the user equipment 120c in FIG. 1 may have the same or similar configurations. Referring to FIG. 2, the user equipment 120a includes a network device 121, a storage apparatus 122, a display 123, and a processor 124. The network device 121 is connected to the network N1, and the processor 124 is coupled to the network device 121, the storage apparatus 122, and the display 123.

The network device 121 is configured to provide a connection of the user equipment 120a to the network N1, which may be, for example, an electronic element such as a network communication chip, or an antenna, etc. that supports an Ethernet protocol, a Wi-Fi communication protocol, a 3G communication protocol, a 4G communication protocol, or a 5G communication protocol.

The storage apparatus 122 is configured to store data, instructions, codes, software elements, and other data, and may be, for example, any type of fixed or removable random access memory (RAM), read-only memory (ROM), flash memory, and hard disk or other similar apparatuses, integrated circuits, and a combinations thereof.

The processor 124 is configured to control actions between members of the user equipment 120a, and is, for example, a central processing unit (CPU), or other programmable general-purpose or special-purpose microprocessors, a digital signal processor (DSP), a programmable controller, an application specific integrated circuit (ASIC), a programmable logic device (PLD), a graphics processing unit (GPU), or other similar apparatuses or a combination of the apparatuses. The processor 130 may execute the codes, the software elements, and the instructions, etc. recorded in the storage apparatus 122 to implement the method for the live streaming activity in the present embodiment of the disclosure.

In addition, in an embodiment, the user equipment 120a may further include a camera element and an audio recording element (not shown). The camera element and the audio recording apparatus of the user equipment 120a may be configured to generate audio and videos in a live video stream. For example, the audio recording element of the user equipment 120a may record conversation content of an activity participant to broadcast the conversation content along with a live streaming picture of the activity. Alternatively, the camera element of the user equipment 120a may record a video of the activity participant to use images of the activity participant as a part of the live streaming picture.

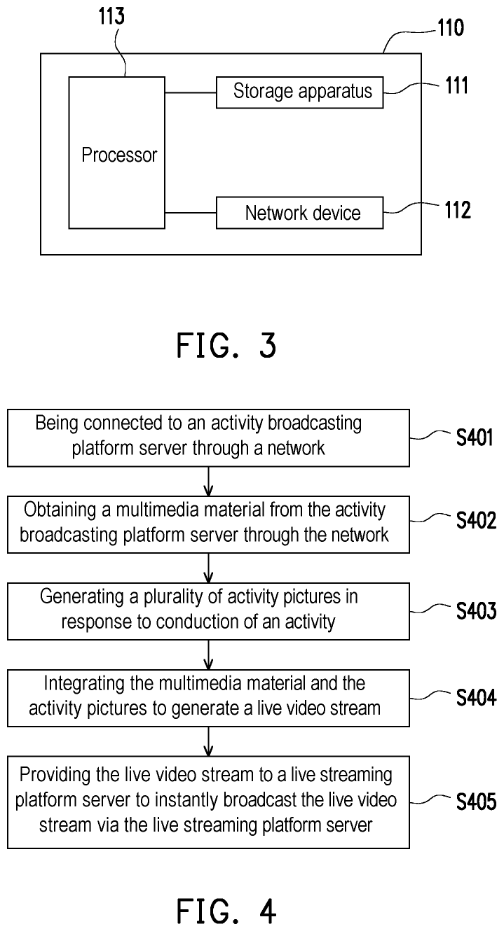

FIG. 3 is a schematic diagram of an activity broadcasting platform server according to an embodiment of the disclosure. Referring to FIG. 3, the activity broadcasting platform server 110 includes a storage apparatus 111, a network device 112, and a processor 113. The activity broadcasting platform server 110 provides an activity live streaming platform. A registered user of the activity live streaming platform may use the multimedia material in the database D1 to enrich live streaming content.

The network device 112 is configured to provide a connection of the activity broadcasting platform server 110 to the network N1, which may be, for example, an electronic element such as a network communication chip, or a connector, etc. supporting the Ethernet protocol.

The storage apparatus 111 is configured to store data, instructions, codes, software elements, and other data, and may be, for example, any type of fixed or removable random access memory (RAM), read-only memory (ROM), flash memory, and hard disk or other similar apparatuses, integrated circuits, and a combinations thereof. In the present embodiment, the database D1 may be recorded in storage apparatus 111.

The processor 113 is configured to control actions between members of the activity broadcasting platform server 110, and is, for example, a central processing unit (CPU), or other programmable general-purpose or special-purpose microprocessors, a digital signal processor (DSP), a programmable controller, an application specific integrated circuit (ASIC), a programmable logic device (PLD), a graphics processing unit (GPU), or other similar apparatuses or a combination of the apparatuses. The processor 113 may execute the codes, the software elements, and the instructions, etc. recorded in the storage apparatus 111 to implement the method for the live streaming activity in the present embodiment of the disclosure.

FIG. 4 is a schematic flow chart of a method for a live streaming activity according to an embodiment of the disclosure. Referring to FIG. 1 and FIG. 4, the method in the present embodiment is applicable to the user equipment 120a in FIG. 1. A detailed process of the method in the present embodiment is described below with reference to each apparatus in FIG. 1. In an embodiment, the user equipment 120a may execute live streaming tool software to produce live streaming content provided to the live streaming platform server 130. In addition, the particular live streaming tool software may provide a user interface for the activity participant (which is also referred to as a live broadcasters or a live host) operating the user equipment 120a to select appropriate multimedia materials through the user interface of the live streaming tool software.

In step S401, the user equipment 120a is connected to the activity broadcasting platform server 110 through the network N1. In step S402, the user equipment 120a obtains the multimedia material from the activity broadcasting platform server 110 through the network N1. Specifically, in an embodiment, the activity participant operating the user equipment 120a may voluntarily select a multimedia material of interest. Alternatively, in an embodiment, the activity broadcasting platform server 110 may automatically provide a specific multimedia material to the user equipment 120a. In other words, in an embodiment, the user equipment 120a may be connected to the database D1 of the activity broadcasting platform server 110 by executing the live streaming tool software to obtain the multimedia material.

In an embodiment, the activity conducted by the user equipment 120a include an e-sports event, and the multimedia material includes at least one of advertisement information, audience interaction information, player information of a plurality of participants of the e-sports event, analysis data on competition of the e-sports event, and event betting data of the e-sports event. The advertisement information is, for example, a manufacturer logo, an advertisement video, or an advertisement image, etc. The audience interaction information is, for example, audience interaction information left by an audience on the webpage established by the activity broadcasting platform server 110, for example, a chat room message, a rating scores, or a number of likes, etc. Thus, in addition to interacting with the live broadcaster and other audiences in the interaction interface of the live streaming platform, the audience may further view the interaction information left by the audience or other audiences on the webpage established by the activity broadcasting platform server 110. In an embodiment, when the activity is an e-sports event, the audience interaction interface established by the activity broadcasting platform server 110 may further include an e-sports event betting interface for users of the platform to place bets. Correspondingly, event betting data of the e-sports event may be embedded into the live streaming picture in the live video stream as one of the multimedia materials.

In step S403, the user equipment 120a generates a plurality of activity pictures in response to conduction of the activity. For example, the user equipment 120a may continue generating a plurality of game pictures in response to conduction of an e-sports competition. In other words, the activity pictures may be application pictures existing when the user equipment 120a executes a game program.

In step S404, the user equipment 120a integrates the multimedia material and the activity pictures to generate a live video stream. Specifically, the user equipment 120a may overlay the multimedia material on a specific corner on the activity picture to generate a live streaming picture in a live video stream. Alternatively, the user equipment 120a may place the multimedia material side by side on a specific activity picture to generate a live streaming picture in a live video stream.

It is worth mentioning that, in an embodiment, before the activity starts and no activity picture is generated, the user equipment 120a may generate a live video stream according to the multimedia material. In particular, the user equipment 120a may combine the multimedia material provided by the activity broadcasting platform server 110 into an opening short video in the live video stream. Alternatively, in an embodiment, when the activity is temporarily stopped and no activity picture is generated, the user equipment 120a may combine the multimedia material provided by the activity broadcasting platform server 110 into a breaking short video in the live video stream. In an embodiment, the user equipment 120a may switch, by using a scenario switching function provided by the live streaming software, between playback of the live streaming picture and playback of the multimedia material provided by the activity broadcasting platform server 110. For example, an e-sports player may switch to playback of the advertisement information provided by the activity broadcasting platform server 110 during game intermission.

In step S405, the user equipment 120a provides the live video stream to the live streaming platform server 130, to instantly broadcast the live video stream via the live streaming platform server 130. In particular, the user equipment 120a may generate the live video stream by performing video compression by using encoding technologies (such as MPEG-2, MPEG-4, H.264, H.265, etc.) and a streaming protocol (such as the RTSP, the UDP, the HTTP, etc.) to transmit the live video stream, so that a live streaming channel of the live streaming platform can immediately broadcast the live video stream including the multimedia material.

It should be noted that, in an embodiment, the user equipment 120a may log into the activity broadcasting platform server 110 according to a user account, so that the user equipment 120a has authority to access the multimedia material. In addition, the user equipment 120a may set a live streaming web address and live streaming time point for the live video stream by using the live streaming tool software, and provide the live streaming web address and the live streaming time point to the activity broadcasting platform server 110. In this way, the webpage associated with the activity presents the live streaming web address and the live streaming time point, and the audience can learn the live streaming time point and obtain the live streaming web address through the webpage established by the activity broadcasting platform server 110. It can be learned that, when a plurality of participants of an activity select live streaming, the webpage established by the activity broadcasting platform server 110 may include a live streaming time point and a plurality of live streaming web addresses set by each activity participant. For example, the webpage established by the activity broadcasting platform server 110 may present live streaming web addresses and live streaming time points of a plurality of e-sports players in the same e-sports event.

In an embodiment, the multimedia material provided by the activity broadcasting platform server 110 includes advertisement information, and the activity broadcasting platform server 110 may determine advertising revenue according to a number of views of the live video stream and provide the advertising revenue to a participant who produces the live video stream. Specifically, the activity participant may choose to place a specific advertisement into the live video stream, and when the number of views of the live video stream increases, the advertising revenue that can be obtained by the participant who produces the live video stream increases. The advertising revenue may be provided to the user account through virtual currency or transaction points.

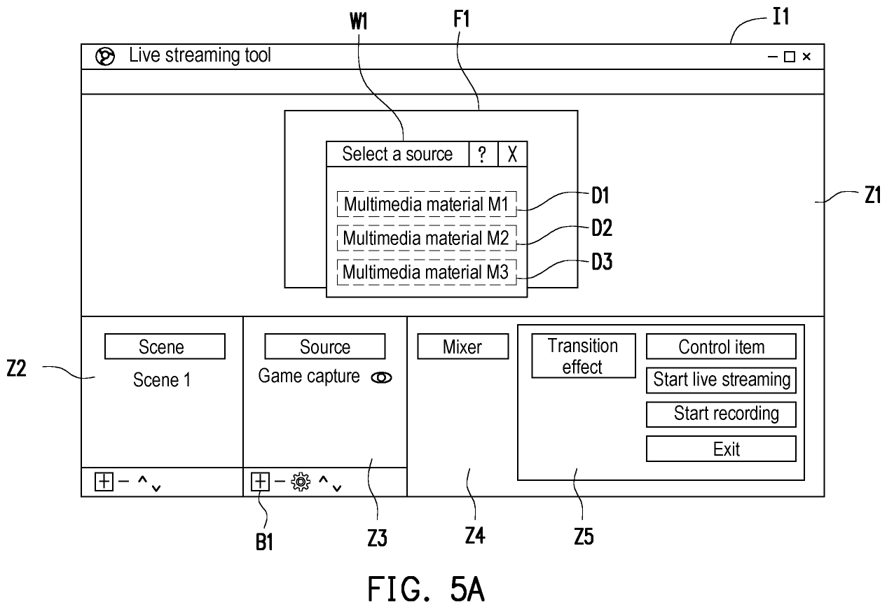

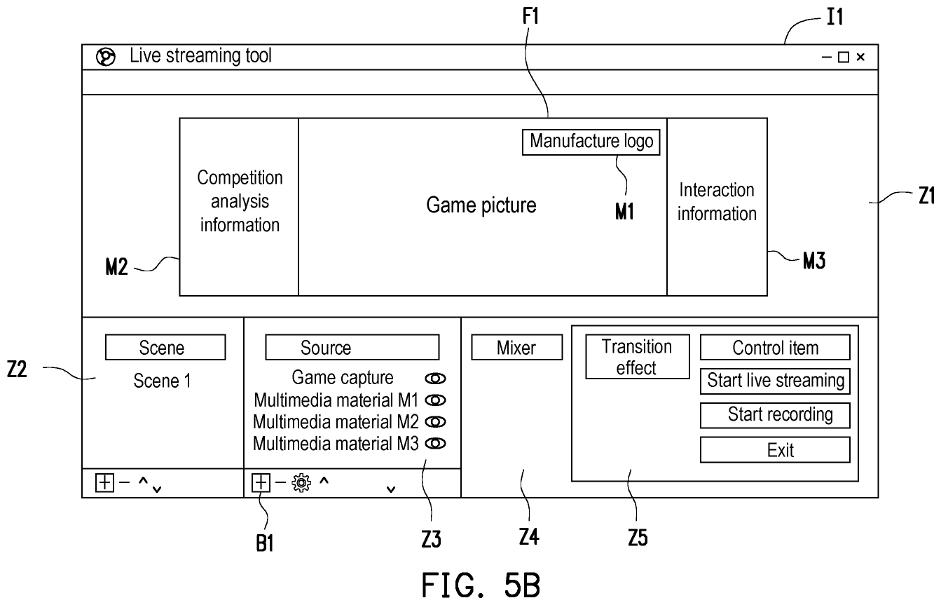

In order to clearly describe the disclosure, description is given below still by using an e-sports competition as an example. FIG. 5A and FIG. 5B are schematic diagrams of a scenario in which a live video stream is generated according to an embodiment of the disclosure. Referring to FIG. 5A, a user interface I1 of the live streaming tool software includes at least a picture layout area Z1, a scene editing area Z2, a source editing area Z3, a mixer area Z4, and a control option area Z5. A pop-up window W1 appears in response to selection of a button B1 in the source editing area Z3. The pop-up window W1 displayed by the user equipment 120a includes options D1 to D3 corresponding to multimedia materials M1 to M3. The multimedia materials M1 to M3 are provided by the activity broadcasting platform server 110 through the network N1. Referring to FIG. 5B, in response to receiving of a selection operation applied to the options D1 to D3 corresponding to the multimedia materials M1 to M3, the user equipment 120a may present the multimedia materials M1 to M3 obtained through the network in the picture layout area Z1. Then, in response to receiving of the editing operation on the multimedia materials M1 to M3 in the picture layout area Z1, the user equipment 120a may move the multimedia materials M1 to M3 to an appropriate display position, for example, overlay the multimedia materials on a corner of a game picture F1 or place the multimedia materials side by side with the game picture F1. Therefore, the audience can view the live streaming content including the game picture F1 and the multimedia materials M1 to M3 through the live streaming broadcast platform.

Therefore, it can be learned that a game player of the user equipment 120a can directly use the live streaming tool software to access the multimedia materials M1 to M3 provided by the activity broadcasting platform server 110. In addition, the multimedia materials M1 to M3 may provide e-sports event information for the activity broadcasting platform server 110, such as player information or competition analysis data of a plurality of players, etc. For example, the multimedia materials M1 to M3 may be pre-competition statistic data, real-time competition statistic data, or post-competition statistic data. The data is generated and provided by the activity broadcasting platform server 110. Based on the above, when a player performs live streaming on a game picture by using the live streaming tool software, the user equipment 120a may obtain game-related data, audience interaction information, and advertisement information from the activity broadcasting platform server 110 through the network. Therefore, the produced live streaming content can achieve effects similar to those of professional broadcasts.

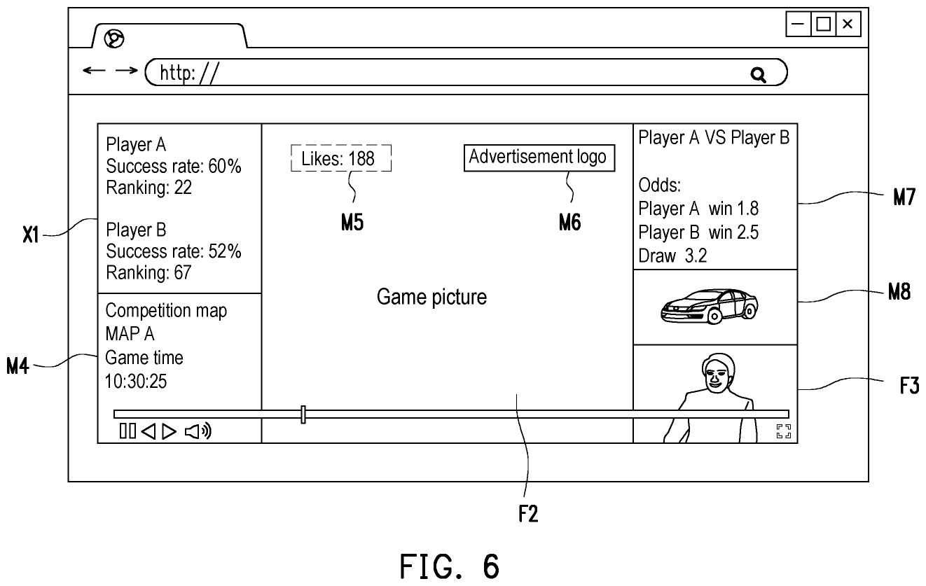

FIG. 6 is an exemplary schematic diagram of a live streaming picture according to an embodiment of the disclosure. The user equipment 120a may generate a live streaming picture X1 shown in FIG. 6 through the live streaming tool software and the live streaming platform server 130. In this example, the user equipment 120a types various multimedia materials M4 to M8 provided by the activity broadcasting platform server 110 into the live streaming picture X1 of the live video stream. In this example, the multimedia material M4 includes player information and game information of two players, such as a game map and a game time, etc. The multimedia material M5 includes a number of likes given by the audience on the webpage created by the activity broadcasting platform server 110. The multimedia material M6 includes an advertisement logo of a manufacturer. The multimedia material M7 includes event betting data of the e-sports event. The multimedia material M8 includes an advertisement video provided by a manufacturer. Therefore, when the audience views, via a connection to the live streaming platform server 130 established through a browser, the live video stream generated by the user equipment 120a, in addition to the game picture F2 and the player image F3, the audience may further view rich information of the multimedia materials M4 to M8, so that the audience obtains experience like viewing professional broadcasts.

An embodiment of the disclosure further provides a non-transitory computer-readable medium. The computer-readable medium may store a plurality of code fragments, and after the code fragments are loaded into the processor 124 of the user equipment 120a and executed, the steps of the above method for the live streaming activity can be completed.

Based on the above, in the embodiments of the disclosure, the user equipment may be connected to the live streaming platform server in real time to obtain the multimedia material in which the audience is interested through the network, so that rich and interesting live streaming content is provided. In addition, when the multimedia material is advertisement information, the advertising revenue may be determined according to the number of views of the live video stream, so that the participants are willing to perform live streaming on the activity. The activity broadcasting platform server may further instantly push activity-related information to the user equipment, so that the live streaming content generated by the user equipment may include the pushing information of the activity broadcasting platform server. In addition, the webpage created by the activity rebroadcasting platform server may include the live streaming information of the activity and the audience interaction interface, so that the live streaming of the activity can attract attention from increased audiences, and the audiences may thereby enjoy an interesting live streaming viewing experience.

Although the disclosure is described with reference to the above embodiments, the embodiments are not intended to limit the disclosure. A person of ordinary skill in the art may make variations and modifications without departing from the spirit and scope of the disclosure. Therefore, the protection scope of the disclosure should be subject to the appended claims.

What is claimed is:

1. A system for a live streaming activity, comprising:
an activity broadcasting platform server configured to establish a webpage associated with an activity, comprising a database configured to record a multimedia material associated with the activity; and
user equipment connected to the activity broadcasting platform server through a network, obtaining the multimedia material from the activity broadcasting platform server through the network,
wherein the user equipment generates a plurality of activity pictures in response to conduction of the activity, integrates the activity pictures and the multimedia material to generate a live video stream, and provides the live video stream to a live streaming platform server to instantly broadcast the live video stream via the live streaming platform server.

2. The system for a live streaming activity according to claim 1, wherein the user equipment logs into the activity broadcasting platform server according to a user account and sets a live streaming web address and a live streaming time point for the live video stream,
wherein the user equipment provides the live streaming web address and the live streaming time point to the activity broadcasting platform server, so that the webpage associated with the activity presents the live streaming web address and the live streaming time point.

3. The system for a live streaming activity according to claim 1, wherein the user equipment generates the live video stream according to the multimedia material before the activity starts.

4. The system for a live streaming activity according to claim 1, wherein a format of the multimedia material comprises at least one of an image file, a text message, and a video file.

5. The system for a live streaming activity according to claim 1, wherein the multimedia material comprises advertisement information, and the activity broadcasting platform server determines advertising revenue according to a number of views of the live video stream and provides the advertising revenue to a participant who produces the live video stream.

6. The system for a live streaming activity according to claim 1, wherein the webpage established by the activity broadcasting platform server comprises an audience interaction interface for the activity, and the multimedia material comprises interaction information of the audience interaction interface.

7. The system for a live streaming activity according to claim 1, wherein the activity comprises an e-sports event, and the multimedia material comprises at least one of advertisement information, audience interaction information presented on the webpage, player information of a plurality of participants of the e-sports event, analysis data on competition of the e-sports event, and event betting data of the e-sports event.

8. A method for a live streaming activity applicable to user equipment connected to a network, the method comprising:
being connected to an activity broadcasting platform server through a network;
obtaining a multimedia material associated with an activity from the activity broadcasting platform server through the network;
generating a plurality of activity pictures in response to conduction of the activity;
integrating the multimedia material and the activity pictures to generate a live video stream; and
providing the live video stream to a live streaming platform server to instantly broadcast the live video stream via the live streaming platform server.

9. The method for a live streaming activity according to claim 8, further comprising:
logging into the activity broadcasting platform server according to a user account;
setting a live streaming web address and a live streaming time point for the live video stream; and
providing the live streaming web address and the live streaming time point to the activity broadcasting platform server, so that the activity broadcasting platform server provides a webpage presenting the live streaming web address and the live streaming time point.

10. The method for a live streaming activity according to claim 8, wherein before the step of generating the activity pictures in response to conduction of the activity, the method further comprises:
generating the live video stream according to the multimedia material before the activity starts.

11. The method for a live streaming activity according to claim 8, wherein a format of the multimedia material comprises at least one of an image file, a text message, and a video file.

12. The method for a live streaming activity according to claim 8, wherein the activity comprises an e-sports event and the multimedia material comprises at least one of advertisement information, audience interaction information, player information of a plurality of participants of the e-sports event, analysis data on competition of the e-sports event, and event betting data of the e-sports event.

13. User equipment, comprising:
a network device connected to a network;
a storage apparatus; and
a processor coupled to the network device and the storage apparatus and configured to:
be connected to an activity broadcasting platform server through a network;
obtain a multimedia material associated with an activity from the activity broadcasting platform server through the network;
generate a plurality of activity pictures in response to conduction of the activity;
integrate the multimedia material and the activity pictures to generate a live video stream, and
provide the live video stream to a live streaming platform server to instantly broadcast the live video stream via the live streaming platform server.

14. The user equipment according to claim 13, wherein the processor is further configured to:
log into the activity broadcasting platform server according to a user account;
set a live streaming web address and a live streaming time point for the live video stream; and
provide the live streaming web address and the live streaming time point to the activity broadcasting platform server, wherein the activity broadcasting platform server provides a webpage presenting the live streaming web address and the live streaming time point.

15. The user equipment according to claim 13, wherein the processor is further configured to:
generate the live video stream according to the multimedia material before the activity starts.

16. The user equipment according to claim 13, wherein a format of the multimedia material comprises at least one of an image file, a text message, and a video file.

17. The user equipment according to claim 13, wherein the activity comprises an e-sports event, and the multimedia material comprises at least one of advertisement information, audience interaction information, player information of a plurality of participants of the e-sports event, analysis data on competition of the e-sports event, and event betting data of the e-sports event.

18. A computer-readable recording medium recording a computer program, loaded by a processor of user equipment to perform the following steps:
being connected to an activity broadcasting platform server through a network;
obtaining a multimedia material associated with an activity from the activity broadcasting platform server through the network;
generating a plurality of activity pictures in response to conduction of the activity;
integrating the multimedia material and the activity pictures to generate a live video stream; and
providing the live video stream to a live streaming platform server to instantly broadcast the live video stream via the live streaming platform server.
